(19) United States
(12) Patent Application Publication
(10) Pub. No.: US 2012/0190775 A1
(43) Pub. Date: Jul. 26, 2012

(54) COMPOSITE RESIN COMPOSITION

(75) Inventors: Hiroshi Yasuda, Chiba (JP); Jun Konta, Chiba (JP); Atsuhiko Ubara, Chiba (JP)

(73) Assignee: LION IDEMITSU COMPOSITES CO., LTD., Taito-ku, Tokyo (JP)

(21) Appl. No.: 13/383,781

(22) PCT Filed: Jul. 13, 2010
(86) PCT No.: PCT/JP2010/004529

§ 371 Date: Apr. 6, 2012

(30) Foreign Application Priority Data
Jul. 15, 2009 (JP) 2009-166388

(51) Int. Cl. C08K 7/02; C08L 23/12

(52) U.S. Cl. 524/9; 524/583

(57) ABSTRACT

A composite resin composition including a polypropylene-based resin and vegetable fibers that contain 1 wt % or less of organic solvent extractable components, the content of the polypropylene-based resin being 70 to 95 wt %; and the content of the vegetable fibers being 5 to 30 wt %.

### TECHNICAL FIELD

The invention relates to a vegetable fiber-reinforced resin composition containing a polypropylene-based resin and vegetable fibers.

### BACKGROUND ART

In recent years, a thermoplastic resin reinforced by a vegetable fiber such as kenaf or jute has been actively developed at home and abroad. For example, components obtained by subjecting vegetable fiber mats and thermoplastic resin sheets to compression molding are used in automobiles.

Today, carbon dioxide emissions have attracted more attention than ever. It can be admitted that materials using vegetable fibers are materials which are eco-friendly in respect of carbon neutral.

As for thermoplastic resins which have been reinforced with vegetable fibers, a method for manufacturing a fiber-reinforced resin pellet using discontinuous natural fibers as reinforcing fibers is known. By this method, during the production of a pellet of a long fiber-reinforced composite material composed of a polypropylene-based resin and vegetable fibers (jute), impregnation between the resin and the fibers is improved by allowing them to be mechanically twisted.

However, many of vegetable fibers are in the form of cotton, and commercial production of a composite material of a resin and vegetable fibers is difficult.

In order to solve this problem, Patent Document 1 discloses a method in which a plurality of specific yarns which are obtained by twisting vegetable fibers in the form of a string (so-called a hemp string) are used, and the thus obtained strings are then subjected to pultrusion with further twisting, whereby a long-fiber pellet as a composite of a resin and vegetable fibers is produced.

However, normally, vegetable fibers are formed into yarns by twisting discontinuous fibers. Therefore, they are formed into a string by using spinning oil. As the spinning oil, mineral oil or vegetable oil is used. Since vegetable oil has a lower molecular weight than that of the resin, they serve as a mold release agent when a composite is formed by injection molding. They may bleed when it is formed into a shaped body. Therefore, a problem that durability of a coating film or the like is decreased has been pointed out.

When vegetable fibers are used, as in the case of glass fibers which are generally used, while reinforcing effects are improved as the length of long fibers is increased, a problem such as warping or the like may occur.

### Related Art Documents

### Patent Documents

Patent Document 1: JP-A-2001-261844

### SUMMARY OF THE INVENTION

The invention is aimed at providing a composite resin composition which is imparted with reinforcing effects, suffers less warping, and suffers less defective coating due to bleeding out.

The inventors made intensive studies, and as a result, have found that, by allowing the amount of organic solvent extractable components contained in vegetable fibers and the amount of vegetable fibers to be specific, a shaped body suffering from a small degree of warping and a small degree of defective coating due to bleeding out of low-molecular weight components can be obtained. The invention has been made based on this finding.

According to the invention, the following composite resin composition can be provided.

1. A composite resin composition comprising a polypropylene-based resin and vegetable fibers that contain 1 wt % or less of organic solvent extractable components,

the content of the polypropylene-based resin being 70 to 95 wt %; and

the content of the vegetable fibers being 5 to 30 wt %.

2. The composite resin composition according to 1, wherein the organic solvent extractable components are components which are extracted by an organic solvent having a boiling point of 40° C. to 150° C.

3. The composite resin composition according to 1 or 2, wherein the organic solvent extractable components are components which are extracted by an aromatic organic solvent or a chlorine-containing organic solvent.

4. The composite resin composition according to any of 1 to 3, wherein the organic solvent extractable components are components which are extracted by xylene or methylene chloride.

5. The composite resin composition according to any of 1 to 4, wherein the polypropylene-based resin comprises maleic anhydride-modified polypropylene.

6. The composite resin composition according to any of 1 to 5, wherein the average fiber length of the vegetable fibers is 500 to 1000 μm.

7. The composite resin composition according to any of 1 to 6, wherein the vegetable fibers are at least one selected from jute, kenaf, paper powder, cotton fiber and regenerated cellulose fiber.

According to the invention, it is possible to provide a composite resin composition which suffers a small degree of warping and has improved coating properties.

### MODE FOR CARRYING OUT THE INVENTION

The composite resin composition of the invention comprises a polypropylene-based resin and vegetable fibers. The composite resin composition of the invention is characterized in that the amount of organic solvent extractable components is 1 wt % or less. By allowing the amount of the organic solvent extractable components to be 1 wt % or less, it is possible to suppress bleeding out of the low-molecular components in a shaped body of the resin composition. Therefore, a shaped body suffering from a small degree of coating defects can be obtained. It is preferred that the amount of the organic solvent extractable components be 0.1 wt % or less.

The amount of the organic solvent extractable components of vegetable fibers is calculated by a method in which vegetable fibers are treated by a Soxhlet extractor for 3 hours, and a decrease in amount of vegetable fibers before and after the treatment is calculated.

It is preferable to use an organic solvent with a boiling point of 40° C. to 150° C. For example, aromatic organic solvents such as benzene, toluene and xylene or chlorine-containing organic solvents such as methylene chloride can be used. In particular, xylene or methylene chloride can be preferably used. In the invention, it is preferred that the amount of the components extractable with any one of the organic solvents be equal to or less than 1 wt % or less.

The organic solvent extractable components of vegetable fibers can be decreased by degreasing vegetable fibers by an organic solvent, superheated vapor or the like.

As the vegetable fibers, various vegetable fibers such as jute, kenaf, cotton fiber, regenerated cellulose, paper powder or the like can be used. In the invention, it is preferred that at least one vegetable fiber selected from jute, kenaf, paper powder, cotton fibers and regenerated cellulose fibers be used.

As for the form of fibers, it is possible to use mora or sliver before spinning or strings after spinning. Further, it is also possible to use these fibers after degreasing by an organic solvent, super heated vapor or the like. In the meantime, the “mora” means a fiber obtained by keeping jute or the like to be soaked in water and taken out. The “sliver” means a fiber obtained by adding spinning oil or the like to mora, followed by processing by means of a comb-like device, in the state before forming into a string. The “string” means one formed by twisting the sliver in the form of a string.

In the composite resin composition of the invention, the content of a polypropylene-based resin relative to the total of a polypropylene-based resin and vegetable fibers is 70 to 95 wt %, with the content of vegetable fibers being 5 to 30 wt %. As a result, warping or the like of a shaped body can be suppressed, reinforcement effects by reinforcing fibers can be obtained, and heat resistance is improved. It is preferred that the content of a polypropylene-based resin be 70 to 90 wt %.

According to the invention, it is preferred that the average fiber length of vegetable fibers be 500 to 1000 μm. With this range, the accuracy of warping dimension of a shaped product can be maintained.

There are no restrictions imposed on the polypropylene resin used in the invention. For example, any of homopolypropylene, block polypropylene and random polypropylene can be used. As the polypropylene, any of α-polypropylene and β-polypropylene can be used. No restrictions are imposed on the fluidity of the resin. Polypropylene having an appropriate fluidity can be used taking the thickness, volume or the like of a shaped product into consideration.

As for the polypropylene resin, only one propylene resin can be used alone, or two or more propylene resins may be used in combination. For example, properties of a composite resin composition may be improved by additionally compounding an elastomer such as an ethylene-α-olefin copolymer.

In the invention, in order to improve adhesiveness between a polypropylene-based resin and vegetable fibers as well as to improve mechanical strength of a shaped body, various modifiers can be used.

As the modifier, one which is modified by a carboxylic anhydride group or a glycidyl group, or a hydroxyl group, an amino group, a carboxyl group, such as maleic anhydride-modified polypropylene, maleic anhydride-modified polyethylene, ethylene glycidyl methacrylate and a derivative thereof can be used.

In the invention, it is preferred that maleic anhydride-modified polypropylene be contained in a polypropylene-based resin. As a result, the strength of a composite resin composition can be improved.

The amount of the modifier to be compounded is preferably 0.3 to 5 wt % relative to the total amount of a modifier and vegetable fibers, with 1 wt % to 3 wt % being particularly preferable.

The composite resin composition of the invention may be essentially composed of the polypropylene-based resin and vegetable fibers or may be composed only of these components. The “essentially composed of” means that the composition mentioned above is composed only of a polypropylene-based resin and vegetable fibers, and may contain the above-mentioned modifiers or the following additives in addition to these components.

In order to satisfy the required product quality, the composite resin composition of the invention may contain an additive such as an antioxidant, an antistatic agent, a heat-resistant aging agent, a weathering agent, an inorganic filler, a flame retardant or the like.

The composite resin composition of the invention can be produced by mixing the above-mentioned polypropylene-based resin, vegetable fibers or the like. There are no restrictions imposed on the mixing method. They may be mixed by a known method such as a method in which a mixer is used. Further, they may be melt kneaded by means of an extruder or the like.

In respect of handling properties at the time of shaping, it is preferred that a polypropylene-based resin, vegetable fibers or the like be melt-kneaded in advance, followed by processing into a pellet-like form.

For example, irrespective of the state of a fiber, such as mora, sliver or string, a pellet of a composite resin composition can be produced by subjecting powdery vegetable fiber having a length of about 1 mm or more and a polypropylene-based resin to melt kneading by means of a twin extruder or the like, followed by shaping into the form of a pellet, whereby a composite resin composition pellet can be produced.

By shaping a composite resin composition pellet by a known method such as injection molding, a shaped body having a desired shape can be obtained.

Further, a long-fiber pellet obtained by impregnating vegetable fibers in the form of a string, which have been subjected to a degreasing treatment in advance, with a polypropylene-based resin may be processed into a shaped body. In this case, by adjusting the screw compression ratio or the like during the shaping process, the average fiber length of vegetable fibers may be adjusted.

### EXAMPLES

The invention will be explained in more detail with reference to the following examples and comparative examples, which should not be construed as limiting the scope of the invention.

### Example 1

70 wt % of block polypropylene having a melt flow rate (MFR) of 30 (J707G manufactured by Prime Polymer Co., Ltd.) and 30 wt % of jute “mora” as vegetable fibers (manufactured by Koizumi Jute Mills Ltd., which had been cut into a length of 2 mm) were subjected to melt kneading by means of a twin extruder (TEX30 manufactured by the Japan Steel Works, Ltd.), whereby a composite resin composition pellet was obtained. Meanwhile, the amount of xylene extractable components of jute “mora” was 0.08 wt %.

By means of an injection molding machine (J180AD manufactured by the Japan Steel Works, Ltd), this pellet was formed into a disk-like shaped body having a thickness of 2 mm and a radius of 15 cm.

### Examples 2 to 4, 6 and 7

A disk-like shaped body was produced in the same manner as in Example 1, except that the amount of block polypropylene and the kind and amount of vegetable fibers used were changed as shown in Table 1.

The vegetable fibers used are shown below.
A: Mora of jute (manufactured by Koizumi Jute Mills Ltd., one obtained by cutting into a length of 2 mm)
B: Xylene-cleaned product of sliver of jute (manufactured by Koizumi Jute Mills Ltd., one obtained by cutting into a length of 2 mm) (one obtained by immersing 1 kg of sliver in 18 L of xylene overnight, followed by drying)
C: Xylene-cleaned strings of jute (manufactured by Koizumi Jute Mills Ltd.) which had been cut into a length of 2 mm (one obtained by immersing 3 kg of strings in 18 L of xylene overnight, followed by drying).
C1: Xylene-cleaned strings of jute (manufactured by Koizumi Jute Mills Ltd.) (one obtained by immersing 3 kg of strings in 18 L of xylene overnight, followed by drying).
D: Mora of kenaf (one obtained by cutting into a length of 2 mm)
E: Paper powder (manufactured by Oji Kinocloth Co., Ltd. Product Name: Lead Healthy Cooking Paper®, which had been cut into a length of 2 mm)
F: Xylene-cleaned strings of regenerated cellulose (manufactured by Kyokuyo Sangyo Co., Ltd. rayon spanned fiber, 1/−) (one obtained by immersing 3 kg of strings in 18 L of xylene overnight, followed by drying)
G: Mora of jute (manufactured by Koizumi Jute Mills Ltd.) (one obtained by cutting into a length of 1 mm)
H: Methylene chloride-cleaned strings of jute (manufactured by Koizumi Jute Mills Ltd.) (one obtained by immersing 3 kg of strings in 18 L of methylene chloride overnight, followed by drying)

### Example 5

70 wt % of block polypropylene having an MFR of 30 and 30 wt % of a xylene-cleaned product of jute “strings” (C1) were formed into a long-fiber pellet (length: 8 mm) by means of a long-fiber pellet production device (Kobe Steel Ltd.). By means of an injection molding machine (J180AD manufactured by Nippon Steel Corporation), this pellet was formed into a disk-like shaped body having a thickness of 2 mm and a radius of 15 cm.

### Example 8

A disk-like shaped body was produced in the same manner as in Example 5, except that a xylene-cleaned product (F) of regenerated cellulose “string” was used.

### Example 9

A disk-like shaped body was produced in the same manner as in Example 1, except that 68% of block polypropylene with a MFR of 30 was used and 2 wt % of maleic anhydride-modified polypropylene (Yumex 1001, manufactured by Sanyo Chemical Industries, Ltd.) was further used.

### Example 10

A disk-like shaped body was produced in the same manner as in Example 1, except that the “mora” (jute) which has been cut into a length of 1 mm (G) was used instead of the “mora” (jute) which has been cut into a length of 2 mm.

### Example 11

A disk-shaped body was produced in the same manner as in Example 5, except that the methylene chloride-cleaned product (H) of the “string” (jute) was used instead of the “string” (jute) (C1).

For the disk-like shaped body as obtained above, the rate of warping and the coating adhesiveness were evaluated. Further, the average fiber length of the vegetable fibers contained in the shaped body was measured. The components of the resin composition, the kind of the vegetable fibers, the amount of organic solvent extractable components (the amount of xylene extractable components or the amount of methylene chloride extractable components) and the results of evaluation are shown in Tables 1 and 2. Evaluation methods are shown below.

### (1) Method for Measuring the Amount of Organic Solvent Extractable Components

As the extraction solvent, xylene or methylene chloride was used. 100 g of vegetable fibers was cleaned for 3 hours by means of a Soxhlet extractor. The amount of extractable components was calculated from a decrease in amount of vegetable fibers between and after cleaning.

### (2) Method for Measuring the Ratio of Warping and Standards of Judgment Thereof

On a surface plate, a disk-like shaped body (sample) was placed. The amount of warping (D1) of a part of which the degree of warping is largest was measured by means of a height gauge and the amount of warping (D2) of a part on the opposite side which is curved was measured by means of a height gauge. The rate of warping was calculated from D1 and D2 according to the following formula:

Rate of warping=[(D1+D2)/2R]×100(%)

[D1, D2; Amount of warping (mm), R; Radius of sample (150 mm)]

A sample of which the rate of warping was less than 4% was judged to be good and a sample of which the rate of warping was 4% or more was judged to be poor.

### (3) Method for Measuring Coating Properties and Standards for Judgment Thereof

The center of an 80 mm-square injection-molded plate obtained by processing a disk-like shaped body which had been coated by spraying a paint for polypropylene was cut such that a grid pattern in which 10 squares were arranged vertically and laterally at an interval of 1 mm by means of a cutter knife was formed. Cellophane tape (registered trade mark) was adhered to the grid pattern, and the tape was then peeled off. Thereafter, the ratio of an area in the grid pattern of which the coating was peeled was measured.

The areas in which the coating film was peeled were added together, and a case in which the ratio of coating-peeled areas was less than 10% was evaluated as significantly excellent (⊚), a case in which the ratio of coating-peeled areas was peeled was 10% or more and less than 20% was evaluated as good (◯) and a case in which the ratio of coating-peeled areas was 20% or more was evaluated as poor (x).

### (4) Average Fiber Length

A disk-like shaped body was put in xylene which had been heated to 130° C. so that polypropylene was dissolved, followed by filtering, thereby to take out the fibers in the shaped body. After drying in wind, the lengths of 100 fibers were measured by means of a profile projector, and the average value thereof was taken as the average fiber length of the jute in each composition.

TABLE 1

| | Example 1 | Example 2 | Example 3 | Example 4 | Example 5 | Example 6 | Example 7 | Example 8 |
|---|---|---|---|---|---|---|---|---|
| Amount of | 70 | 95 | 70 | 70 | 70 | 70 | 70 | 70 |
| polypropylene (wt %) | | | | | | | | |
| Type of | A | A | B | C | C1 | D | E | F |
| vegetable fibers | | | | | | | | |
| Solvent used | Xylene | Xylene | Xylene | Xylene | Xylene | Xylene | Xylene | Xylene |
| for extraction | | | | | | | | |
| Amount of organic | 0.08 | 0.08 | 1 | 0.12 | 0.12 | 0.08 | 0.03 | 0.05 |
| solvent extractable | | | | | | | | |
| components (wt %) | | | | | | | | |
| Amount of vegetable | 30 | 5 | 30 | 30 | 30 | 30 | 30 | 30 |
| fibers (wt %) | | | | | | | | |
| Ratio of warping (%) | 3 | 2 | 3 | 3.2 | 3 | 2.5 | 2.0 | 2.8 |
| Adhesiveness of | ⊚ | ⊚ | ◯ | ⊚ | ⊚ | ⊚ | ⊚ | ⊚ |
| coating film | | | | | | | | |
| Average fiber length | 780 | 820 | 750 | 750 | 780 | 600 | 520 | 850 |
| (μm) | | | | | | | | |

Type of vegetable fibers
A: Mora of jute (cut into 2 mm)
B: Xylene-cleaned product of sliver of jute
C: Xylene-cleaned product of jute strings (cut into 2 mm)
C1: Xylene-cleaned product of jute strings
D: Mora of kenaf (cut into 2 mm)
E: Paper powder (cut into 2 mm)
F: Xylene-cleaned product of regenerated cellulose

TABLE 2

| | Ex. 9 | Ex. 10 | Ex. 11 | Com. Ex. 1 | Com. Ex. 2 | Com. Ex. 3 | Com. Ex. 4 | Com. Ex. 5 | Com. Ex. 6 |
|---|---|---|---|---|---|---|---|---|---|
| Amount of | 68 | 70 | 70 | 70 | 95 | 70 | 70 | 70 | 70 |
| polypropylene (wt %) | | | | | | | | | |
| Amount of modifier | 2 | — | — | — | — | — | — | — | — |
| (wt %) | | | | | | | | | |
| Type of | A | G | H | B′ | B′ | C′ | C′ | C′ | B′ |
| vegetable fiber | | | | | | | | | |
| Solvent used | Xylene | Xylene | Methylene | Xylene | Xylene | Xylene | Xyelene | Xylene | Xylene |
| for extraction | | | chloride | | | | | | |
| Amount of xylene | 0.08 | 0.08 | 0.15 | 2 | 2 | 2.5 | 2.5 | 2.5 | 2.7 |
| extractable | | | | | | | | | |
| components (wt %) | | | | | | | | | |
| Amount of vegetable | 30 | 30 | 30 | 30 | 5 | 30 | 30 | 30 | 30 |
| fibers (wt %) | | | | | | | | | |
| Rate of warping (%) | 3 | 2 | 3 | 3 | 2 | 3 | 3 | 7 | 5 |
| Adhesiveness of | ⊚ | ⊚ | ⊚ | X | X | X | X | X | X |
| coating film | | | | | | | | | |
| Average fiber length | 980 | 500 | 780 | 750 | 820 | 750 | 780 | 1500 | 1120 |
| (μm) | | | | | | | | | |

Type of vegetable fibers
A: Mora of jute (2 mm)
G: Mora of jute (1 mm)
H: Methylene chloride-cleaned product of jute strings
B′: Uncleaned product of jute slivers
C′: Uncleaned product of jute strings

### Comparative Example 1

A disk-like shaped body was produced in the same manner as in Example 1, except that an uncleaned product B′ of the “sliver” (jute) B used in Examples was used. The results of evaluation are shown in Table 2.

### Comparative Example 2

A disk-like shaped body was produced in the same manner as in Example 2, except that an uncleaned product B′ of the “sliver” (jute) B used in Examples was used. The results of evaluation are shown in Table 2.

### Comparative Example 3

A disk-like shaped body was produced in the same manner as in Example 1, except that an uncleaned product C′ of the “string” (jute) C used in Examples was used. The results of evaluation are shown in Table 2.

### Comparative Example 4

A disk-like shaped body was produced in the same manner as in Example 5, except that an uncleaned product C′ of the “string” (jute) C used in Examples was used. The results of evaluation are shown in Table 2.

### Comparative Example 5

A long-fiber pellet (length: 8 mm) containing 40 wt % of vegetable fibers was produced by means of a long-fiber pellet production device (manufactured by Kobe Steel, Ltd.) by using 60 wt % of block polypropylene having an MFR of 30 and an uncleaned product C′ of the “string” (jute) C used in Examples.

The thus obtained pellet and a pellet of block polypropylene having an MFR of 30 were mixed and an adjustment was made such that the amount of vegetable fibers becomes 30 wt %. This mixture of the pellets was formed into a disk-like shaped body having a thickness of 2 mm and a radius of 15 cm by means of an injection molding machine (J180AD manufactured by the Japan Steel Works, Ltd.), and evaluated in the same manner as in Example 1. The results are shown in Table 2.

### Comparative Example 6

A disk-like shaped body was produced in the same manner as in Example 1, except that an uncleaned product B′ of the “sliver” (jute) B used in Examples which had been cut into a length of 10 mm was used. The results are shown in Table 2.

### INDUSTRIAL APPLICABILITY

The composite resin composition of the invention can be used in exterior parts (a bumper, a cable cover, a spoiler, for example), automobile components such as components inside an engine room and interior parts (an instrument panel, a trim package, for example), and distribution materials such as pallets, containers, wagons and shopping baskets.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification are incorporated herein by reference in its entirety.

1. A composite resin composition comprising a polypropylene-based resin and vegetable fibers that contain 1 wt % or less of organic solvent extractable components,
the content of the polypropylene-based resin being 70 to 95 wt %; and
the content of the vegetable fibers being 5 to 30 wt %.

2. The composite resin composition according to claim 1, wherein the organic solvent extractable components are components which are extracted by an organic solvent having a boiling point of 40° C. to 150° C.

3. The composite resin composition according to claim 1, wherein the organic solvent extractable components are components which are extracted by an aromatic organic solvent or a chlorine-containing organic solvent.

4. The composite resin composition according to claim 1, wherein the organic solvent extractable components are components which are extracted by xylene or methylene chloride.

5. The composite resin composition according to claim 1, wherein the polypropylene-based resin comprises maleic anhydride-modified polypropylene.

6. The composite resin composition according to claim 1, wherein the average fiber length of the vegetable fibers is 500 to 1000 μm.

7. The composite resin composition according to claim 1, wherein the vegetable fibers are at least one selected from jute, kenaf, paper powder, cotton fiber and regenerated cellulose fiber.
